(19) United States
(12) Patent Application Publication
(10) Pub. No.: US 2021/0195679 A1
(43) Pub. Date: Jun. 24, 2021

(54) METHOD FOR DETECTING WI-FI CLIENT ACTIVITY STATUS

(71) Applicant: ARRIS Enterprises LLC, Suwanee, GA (US)

(72) Inventor: Penghui ZHAO, Shenzhen (CN)

(21) Appl. No.: 16/772,367

(22) PCT Filed: Dec. 12, 2017
(86) PCT No.: PCT/CN2017/115745

§ 371 Date: Jun. 12, 2020

(51) Int. Cl. H04W 76/25; H04W 24/06

(52) U.S. Cl. CPC H04W 76/25; H04W 84/12; H04W 24/06

(57) ABSTRACT

A method for detecting activity status of a wireless client is provided. The method includes transmitting a Quality of Service (QoS) Null Data frame wireless transmission from an access point (AP) of a wireless local area network (WLAN) to a wireless client on an active status wireless client list of the AP and detecting for receipt by the AP of an Acknowledgement (ACK) frame wireless transmission from the wireless client in response to the QoS Null Data frame transmission. If an ACK frame wireless transmission is not received by the AP within a predetermined period of time, the wireless client is removed from the active status wireless client list of the AP and thereby free to quickly connect to the AP via a different frequency band. A network hardware device is also provided.

### BACKGROUND

The Institute of Electrical and Electronics Engineers (WEE) 802.11 standards refer to a family of specifications developed by the IEEE for wireless local area network (WLAN) technology. These standards specify over-the-air interface between a wireless client and a base station, such as a wireless router, access point, or other networking hardware device of a WLAN, or between two wireless clients and provide a set of media access control (MAC) and physical layer (PHY) specifications for implementing WLAN communication in the 900 MHz and 2.4, 3.6, 5, and 60 gigahertz (GHz) frequency bands.

A typical access point or router, such as a dual-band router, may support radio-wave wireless communications in two or more different frequency bands, such as for instance, 5 and 2.4 GHz bands. Thus, 5 GHz and 2.4 GHz refer to two different bands that a Wi-Fi client may use to communicate with the base station, router, or access point of a WLAN.

Typically, a 2.4 GHz Wi-Fi connection may support a communication speed of up to about 450 Mbps or 600 Megabits per second (Mbps), depending upon class of router and other network conditions. “Mbps” is a unit of measurement for bandwidth and throughput of a network. Each megabit is equal to 1 million bits. In comparison, a 5 GHz Wi-Fi connection may support communication speeds of up to about 1300 Mbps.

Primary differences between the above referenced frequency bands are the range of coverage and bandwidth (speed). The 2.4 GHz band may provide coverage at a longer range but transmits data at slower speeds, and the 5 GHz band provides less coverage but transmits data at faster speeds. The range of coverage is lower in the 5 GHz band because higher frequencies do not penetrate solid objects, such as walls and floors, as readily as the 2.4 GHz band. However, higher frequencies allow data to be transmitted faster than lower frequencies, so the 5 GHz band allows faster upload and download of data to/from a wireless client.

In certain circumstances, a wireless client may connect to a wireless access point (AP) of a wireless local area network at one of the above referenced frequency bands and then later may automatically switch to a different available band provided by the AP as conditions dictate such a switch. For example, a wireless client may originally connect to an AP via the 5 GHz Wi-Fi band to take advantage of faster data transmission and then may later automatically switch to the 2.4 GHz Wi-Fi band if the received signal strength indicator (RSSI), a measurement of the power present in a received radio signal, is determined to be below a preset threshold level relative to communications over the 5 GHz Wi-Fi band. For instance, the wireless client may move outside of a reliable or stable coverage range of the 5 GHz Wi-Fi band.

Problems may be encountered with the above referenced switch in that the wireless AP may not possess information that the wireless client intended to disconnect from the 5 GHz Wi-Fi band. For instance, a disassociation frame typically transmitted by the wireless client to the AP over the 5 GHz band to disconnect from the band may not have been properly received by the AP (i.e., due to RSSI being too weak). In this situation, the wireless client would unintentionally remain on active status on the 5 GHz band channel client list of the AP until after timeout of a conventional client inactivity timer. Such a conventional timer typically has a setting of about 300 seconds (5 minutes) or more. During this time, the user of the wireless client will be prevented from access to the Wi-Fi network despite the wireless client indicating to the user that an active and valid Wi-Fi connection exists. However, in reality, a connection cannot be made until after the five-minute timeout expires.

### SUMMARY

According to an embodiment, a method of detecting an activity status of a wireless client is provided. The method includes the steps of transmitting a Quality of Service (QoS) Null Data frame wireless transmission from an access point (AP) of a wireless local area network (WLAN) to a wireless client on an active status wireless client list of the AP and detecting for the receipt by the access point of an Acknowledgement (ACK) frame wireless transmission from the wireless client in response to the QoS Null Data frame transmission. The method includes a step of removing the wireless client from the active status wireless client list of the access point if an ACK frame wireless transmission is not received by the AP within a relatively short predetermined period of time, such as 10 seconds.

According to another embodiment, a network hardware device is provided. The network hardware device provides an access point (AP) of a wireless local area network (WLAN) and comprises at least one processor configured to cause the access point to transmit a Quality of Service (QoS) Null Data frame wireless transmission to a wireless client on an active status wireless client list of the AP and to detect for an Acknowledgement (ACK) frame wireless transmission received from the wireless client in response to the QoS Null Data frame transmission. If an ACK frame transmission is not received by the AP within a predetermined period of time from the wireless client, the wireless client is removed from the active status wireless client list of the AP.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a schematic view of a dual band access point and the range of coverage of the bands relative to the movement of a wireless client in accordance to an embodiment.

FIG. 2 is a flow chart of a computer program for actively determining an actual activity status of a wireless client relative to a frequency band of an access point in accordance to an embodiment.

FIGS. 3A and 3B provide a sample of a printout of a computer display of a wireless packet air capture tool showing information concerning the transmission of QoS Null Data packets and return ACK packets in accordance to an embodiment.

FIG. 4 shows a flow chart of a process for actively determining an actual activity status of a wireless client relative to a frequency band of an access point in accordance to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

The term “Wi-Fi” as used herein refers to a technology for wireless local area networking with devices, for instance, as based on IEEE 802.11 standards.

These standards define various frame types that stations (network interface cards and access points) use for communications, as well as managing and controlling wireless links.

Every frame has a control field that depicts the 802.11 protocol version, frame type, and various indicators. In addition, frames contain Media Access Control (MAC) addresses of the source and destination station (and access point), a frame sequence number, frame body and frame check sequence (for error detection).

A Media Access Control (MAC) address is a hardware address that uniquely identifies each node of a network.

The 802.11 data frames carry protocols and data from higher layers within the frame body. A data frame, for example, may carrying the HTML code from a Web page (complete with TCP/IP headers) that the user is viewing. Other frames that stations use for management and control carry specific information regarding the wireless link in the frame body. For example, a beacon's frame body contains the service set identifier (SSID), timestamp, and other pertinent information regarding the access point.

The SSID is a network name which is typically provided as a case sensitive, thirty-two alphanumeric character, unique identifier attached to the header of packets sent over a wireless local area network (WLAN).

The SSID differentiates one WLAN from another, so all access points and all devices attempting to connect to a specific WLAN must use the same SSID to enable effective roaming. As part of the association process, a wireless network interface card (NIC) must have the same SSID as the access point or it will not be permitted to join the basic service set (BSS)—a component of the IEEE 802.11 WLAN architecture. When a wireless client switches frequency bands on the same access point, such as from a 5 GHz band to a 2.4 GHz band, it necessarily must utilize the same SSID in both bands.

A data frame is a basic frame containing data. There are about fifteen different types of data frames defined in the IEEE 802.11-2007 standard. Quality of Service (QoS) data is the QoS version of a data frame. Thus, data frames with a value of “1” in the Quality of Service (QoS) subfield of the subtype field (bit7) are collectively referenced to as QoS data frames. A Null frame is a frame meant to contain no data but flag information, and a QoS Null Data frame is the QoS version of the null frame. Data frames with a value of “1” in the Quality of Service (QoS) subfield of the subtype field (bit7) and with a value of “1” in the null (no data) subfield of the subtype (bit6) are referenced to as QoS Null Data frames.

As used herein, a wireless AP refers to any networking hardware device that allows a Wi-Fi client device to connect to a network. A wireless client or Wi-Fi client refers to any electronic device capable of communicating with the AP, such as smartphones, tablet computers, laptops, and any device capable of Wi-Fi connection including set top boxes and like equipment. The AP or related equipment maintains a separate active status client list for each frequency band of communications available by the AP, and a wireless client may only be provided with active status on one frequency bands of the AP at any given point in time.

In accordance to IEEE 802.11 standards, the wireless access point (AP) is configured to passively wait for client activity relative to determining the active status of a specific wireless client. If no activity occurs within a predetermined period of time, typically about 300 seconds or more, an inactivity timer times-out and the wireless client is automatically removed from the active client list of the AP. This conventional process provides so-called “passive” detection of wireless client activity/inactivity.

According to embodiments disclosed herein, the AP periodically or continually utilizes a process which actively detects for an actual connection status of a Wi-Fi or wireless client and uses a Wi-Fi QoS Null Data frame transmission, discussed above, and return Acknowledgment (ACK) frame transmission for this purpose. Thus, the AP actively checks to see if the wireless client remains active in a particular frequency band offered by the AP and maintains an active client list based on this information which is continually updated.

An ACK frame is a management data frame. The ACK frame is typically used after a receiving station receives a data frame and utilizes an error checking process to detect the presence of errors in the transmission, and if no errors are determined, the receiving station sends an ACK frame to the sending station. If the sending station fails to receive an ACK frame after a period of time, the sending station retransmits the data frame. However, in the embodiments disclosed herein, the ACK frame is used to respond to a Wi-Fi QoS Null Data frame for purposes of determining whether or not a wireless client remains active relative to a frequency band channel of the AP.

By way of example, if a wireless client device fails to respond to the above referenced AP detection, then the AP automatically and substantially immediately determines the wireless client as being disconnected from the AP and removes the wireless client from the active wireless client list of the AP as opposed to the conventional passive process of waiting a relatively long period of time necessary for a timeout of an inactivity timer which may be set for five minutes or more. As discussed above, during the duration of the inactivity timer (i.e., typically about 5 minutes), the wireless client cannot reconnect to the AP since the AP considers the wireless client as already being connected, when, in reality, it is not.

Thus, the benefit of an active activity status detection process is that the wireless client may switch from one frequency band to another provided by the same access point and same SSID without significant actual loss of Wi-Fi connection such as would occur when waiting the full duration of an inactivity timeout as discussed above.

According to one embodiment, an AP or like networking hardware device is configured to run a daemon (i.e., a computer program that runs as a background process that is not under the direct control of an interactive user) which may obtain or get a list of wireless clients that have an active status relative to a particular frequency band of an AP and cause one or more, such as three, QoS Null Data packets (i.e., wireless transmissions) to be transmitted to each wireless client on the client list of a channel or band of the AP. In response to the QoS Null Data packets sent by the AP to the wireless clients, the wireless clients respond with an Acknowledgement (ACK) frame or packet.

According to embodiments, the AP detects whether a wireless client returns an ACK packet in response to a transmitted QoS Null Data frame and, if the AP fails to receive an ACK packet from the wireless client within a predetermined period of time, then the AP automatically determines that the client device is no longer actively connected to the AP. The predetermined period of time may be 20 seconds or less, or may be with a range of 5 to 15 seconds. As an example, the predetermined period of time may be 10 seconds.

After the predetermined period of time expires without an ACK packet being received for a particular wireless client, the AP automatically removes the wireless client from the active status client list thereby enabling the wireless client to reconnect to the AP at the same or a different frequency band.

Accordingly, the above described active wireless client activity status detection process is accomplished rapidly relative to the conventional passive timeout process discussed above and thereby provides greater freedom for a wireless client to switch with no or little delay between two different frequency bands available via the same access point using the same SSID.

Accordingly, in a scenario in which a Wi-Fi client losses acceptable signal strength for a 5 GHz band connection of the AP and attempts to automatically switch to a 2.4 GHz band connection to the same AP (with the same SSID), the Wi-Fi client is able to quickly reconnect and have actual Wi-Fi service via the 2.4 GHz band. As stated above, in this scenario, although the AP is unaware of the loss of signal strength of the Wi-Fi client because a disassociation frame transmitted by the Wi-Fi client is never sufficiently received over the 5 GHz band by the AP due to RSSI being too weak, the AP is still able to quickly remove the Wi-Fi client from active status on the 5 GHz band.

A disassociation frame is a management frame sent by a wireless client to an AP when the wireless client desires to terminate an association with the AP on a particular frequency band offered by the AP. As an example, a radio NIC of a wireless client may transmit a disassociation frame to alert the access point that the NIC is powering off. If this occurs, the access point can then relinquish memory allocations and remove the radio NIC from the association table. However, in the above described scenario, if signal strength is suddenly reduced due to distance, the presence of walls, etc., a dissociation frame transmitted by the wireless client may never actually be received by the AP. In this case, the wireless client would unnecessarily remain on the active status client list for about five minutes as discussed above which would thereby prevent the wireless client from quickly and fully reconnecting to the AP via a different frequency band.

In an IEEE 802.11 system, RSSI is the relative received signal strength in a wireless environment, in arbitrary units. RSSI is an indication of the power level being received by the receive radio after the antenna and possible cable loss. Therefore, the higher the RSSI number, the stronger the signal. Thus, when an RSSI value is represented in a negative form (e.g. −100), the closer the value is to 0, the stronger the received signal has been.

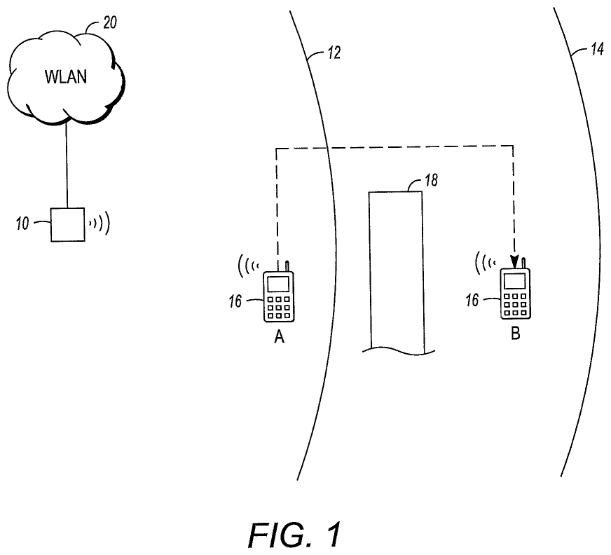

FIG. 1 discloses an access point 10 having a dual-band router. The 5 GHz band is preferred but has a smaller coverage range 12. The 2.4 GHz band provides a wider range of coverage 14. Thus, when wireless client 16 connects to the AP 10 via the 5 GHz band and then moves (see dashed lines in FIG. 1) from point “A” to point “B” (beyond building structure 18), the wireless client 16 losses a reliable and stable connection to the WLAN 20 via the AP 10. Accordingly, the wireless client 16 is configured to automatically attempt to disconnect from the 5 GHz band and then reconnect to the AP 10 via the 2.4 GHz band. Unfortunately, with the wireless client 16 located at point “B”, the dissociation frame transmitted by the wireless client 16 over the 5 GHz band, never reliably reaches the AP 10. Thus, the wireless client 16 remains on an active status client list for the 5 GHz band for the duration of a five-minute or greater inactivity timer.

During this time, the wireless client 16 has already connected to the WLAN 20 over 2.4 GHz, and since it is out of range of the 5 GHz band coverage 12 and since it remains in active status on the 5 GHz band, all packets transferred between client 16 to WLAN 20 will fail. Thus, client 16 can connect to 2.4 GHz, because it has already lost 5 GHz connection; however, the AP and WLAN 20 still believe the client 16 is on 5 GHz, so all Wi-Fi packets will be sent on the 5 GHz band. Accordingly, during this time, the client 16 will not have data transfer even it connects to the 2.4 GHz band.

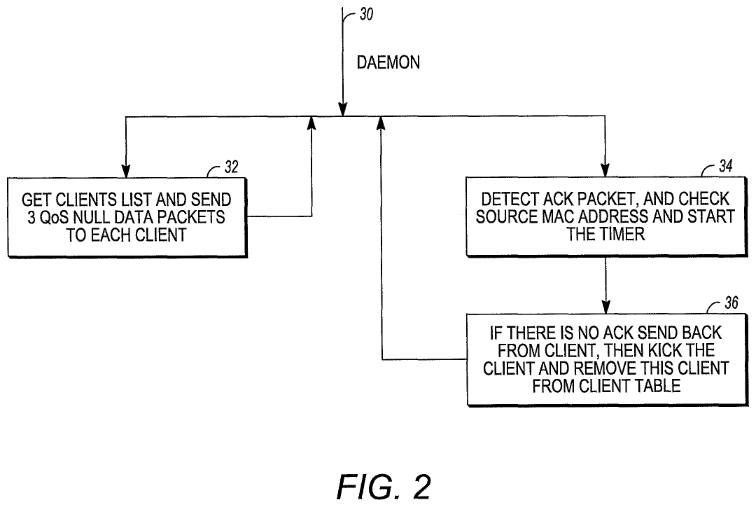

However, if the access point or network hardware device has at least one processor configured with a computer program or daemon 30 as shown in FIG. 2, the switch from the 5 GHz band in FIG. 1 to the 2.4 GHz band may occur substantially immediately with little or no noticeable delay. In FIG. 2, the program 30 continually or periodically pulls or gets the active status wireless client list from the AP for a predetermined frequency band and then transmits one or more, such as three, QoS Null Data packets or frames to each wireless client on the active status wireless client list (see step 32).

The program 30 and/or AP then detects ACK packets or frames being transmitted to the AP by wireless clients on the active status wireless client list and checks the source MAC address of each wireless client from which an ACK transmission is received to identify a particular wireless client to a corresponding received acknowledgement. In addition, the program 30 or AP initiates a timer (see step 34). Wireless clients that return a ACK packet or frame remain connected to the AP and remain on the active status wireless client list. However, if no ACK packet or frame is received by the AP from a particular wireless client on the active status wireless client list as of the timeout of the timer (for instance, for a time of ten seconds), the particular wireless client is immediately removed from the client list or association table and is considered disconnected (see step 36). At this point, the wireless client is free to immediately reconnect and establish a fully functioning connection to the AP and WLAN on the same or different frequency band provided by the AP.

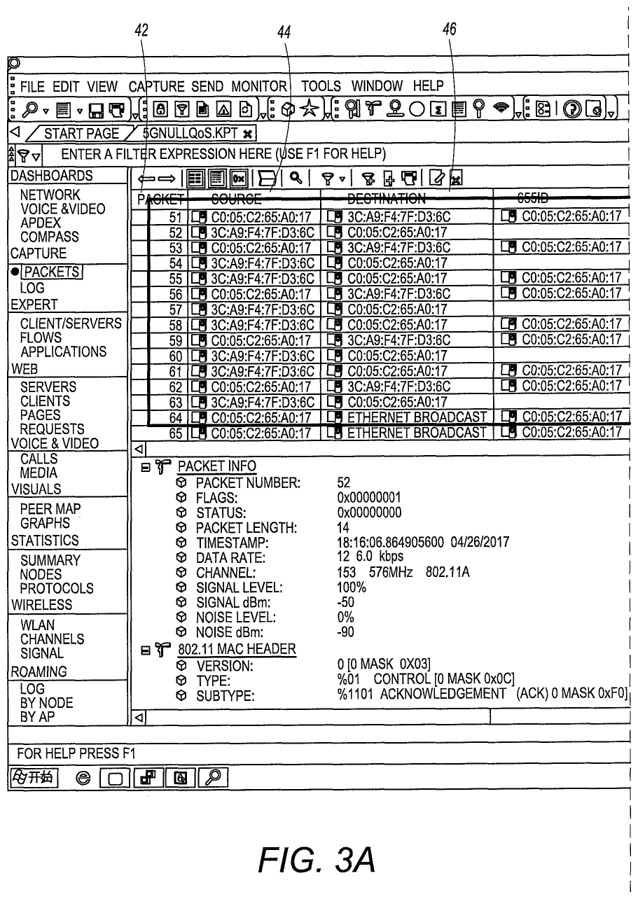

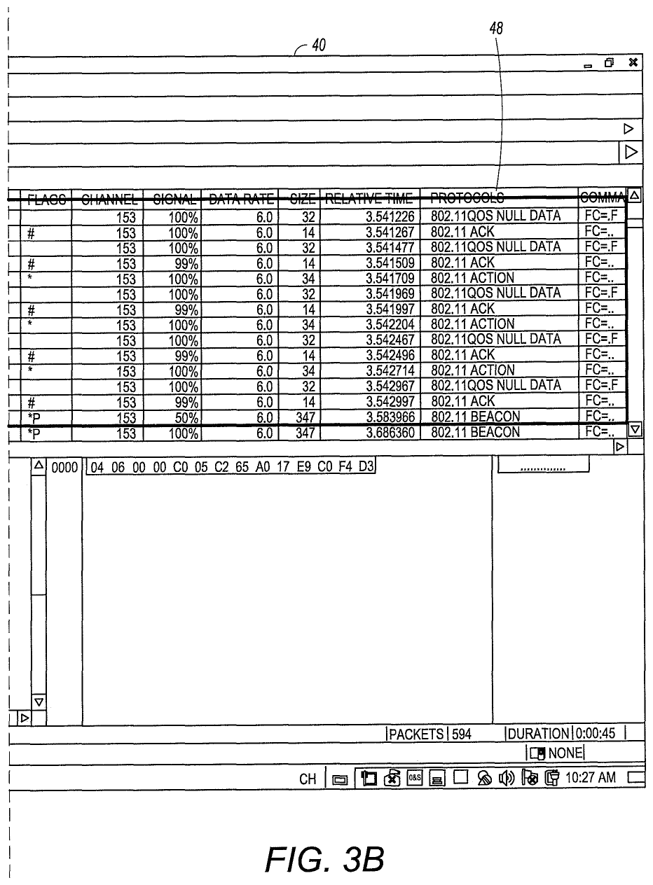

FIG. 3 is a screen print 40 showing a log of packets sent and received by an AP. The packet number is provided in column the first column 42, the source of the transmission is shown in the second column 44, the destination of the transmission is shown in the third column 46, and the type of transmission is shown in the next to last column 48 of FIG. 3. As shown for packet number 51, the AP sends a QoS Null Data frame or packet to a particular wireless client and for packet number 52, the wireless client responds with an ACK frame. Thus, the wireless client remains within a range of coverage of the AP and remains on the active status wireless list of the AP. This same sequence is repeated four more times as shown in FIG. 3 (i.e., see packets 53 and 54, 56 and 57, 59 and 60, and 62 and 63).

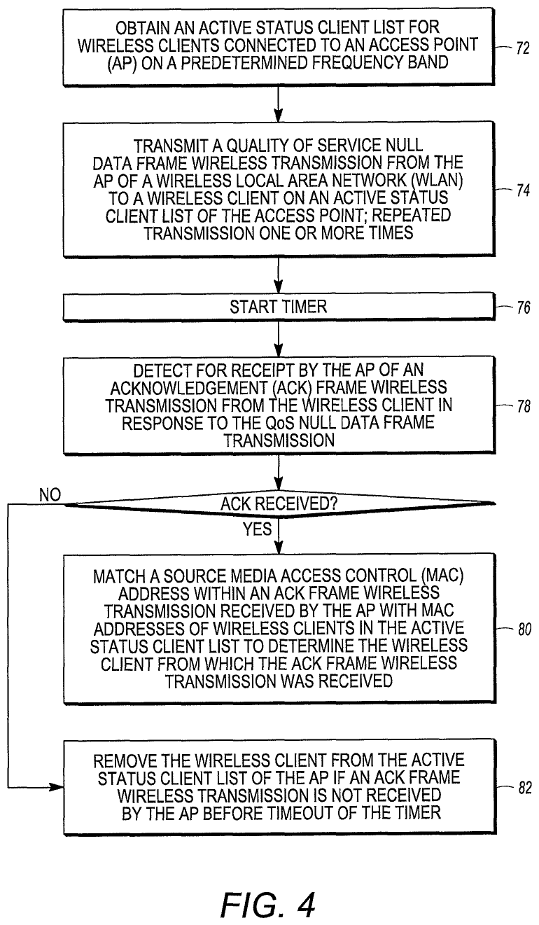

FIG. 4 provides a method of an embodiment of actively detecting the activity status of a wireless client indicated as being connected to the AP. In step 72 an active status client list of wireless clients of an AP is obtained. In step 74, a QoS Null Data frame wireless transmission is transmitted by the AP to wireless clients on the active status list. This step may be repeated. In step 76, a timer is started (i.e., a 10 second timer or the like). In step 78, ACK frame wireless transmissions from wireless devices in response to the QoS Null Data frame wireless transmissions are detected at the AP. If an ACK frame is received, the MAC address within the ACK transmission is matched to one of the wireless clients on the active status client list and the matched wireless client remains on the active status list (see step 80). Alternatively, if an ACK transmission is not received from a wireless client before timeout of the timer, the wireless client is immediately removed from the active status client list (see step 82).

A system for carrying out any of the above disclosed methods or arrangements may include software or the like provided on a circuit board or within another electronic device and can include various processors, microprocessors, modules, units, components, controllers, chips, disk drives, and the like. It will be apparent to one of ordinary skill in the art that systems, modules, components, units, processors, servers, and the like may be implemented as electronic components, software, hardware or a combination of hardware and software for purposes of providing a system.

Embodiments may also include at least one non-transitory computer readable storage medium having computer program instructions stored thereon that, when executed by at least one processor, can cause the at least one processor to perform any of the steps described above.

While the principles of the invention have been described above regarding specific devices, apparatus, systems, algorithms, and/or methods, it is to be clearly understood that this description is made only by way of example and not as limitation. One of ordinary skill in the art will appreciate that various modifications and changes can be made without departing from the scope of the claims below.

The above description illustrates various embodiments along with examples of how aspects of particular embodiments may be implemented, and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims.

We claim:

1. A method for detecting activity status of a wireless client, comprising the steps of:
transmitting a Quality of Service (QoS) Null Data frame wireless transmission from an access point (AP) of a wireless local area network (WLAN) to a wireless client on an active status client list of the AP;
detecting, for receipt by the AP of an Acknowledgement (ACK) frame, a wireless transmission from the wireless client in response to the QoS Null Data frame transmission; and
removing the wireless client from the active status client list of the AP if an ACK frame wireless transmission is not received by the AP within a predetermined period of time.

2. The method according to claim 1, wherein the predetermined period of time is 20 seconds or less.

3. The method according to claim 1, wherein the predetermined period of time is about 5 to 15 seconds.

4. The method according to claim 1, wherein the predetermined period of time is about 10 seconds.

5. The method according to claim 1, wherein during the transmitting step, the QoS Null Data frame wireless transmission by the AP is repeated.

6. The method according to claim 5, wherein during the detecting step, if at least one ACK frame wireless transmission is received by the AP from the wireless client within the predetermined period of time, the wireless client is maintained on the active status client list of the AP.

7. The method according to claim 1, wherein wireless communication with the AP is available to wireless clients over multiple channels of different frequency bands, and wherein the AP maintains a separate active status client list for each of the different frequency bands.

8. The method according to claim 7, wherein the different frequency bands include a 5 GHz band and a 2.4 GHz band between which the wireless client may switch.

9. The method according to claim 1, further comprising the steps of:
obtaining an active status client list for wireless clients connected to the AP on a predetermined frequency band, before the transmitting step; and
starting a timer after the transmitting step for determining if an ACK frame wireless transmission is received by the AP within the predetermined period of time.

10. The method according to claim 1, further comprising the step of:
matching a source media access control (MAC) address within any ACK frame wireless transmission received by the AP with MAC addresses of wireless clients in the active status client list, to determine the wireless client from which the ACK frame wireless transmission was received.

11. A network hardware device providing an access point (AP) of a wireless local area network (WLAN), comprising at least one processor configured
to cause the AP to transmit a Quality of Service (QoS) Null Data frame wireless transmission to a wireless client device that is listed on an active status client list of the AP, and
to detect, for an Acknowledgement (ACK) frame, a wireless transmission received from the wireless client device in response to the QoS Null Data frame transmission,
such that, if an ACK frame transmission is not received by the AP within a predetermined period of time from the wireless client device, the wireless client device is removed from the active status client list of the AP.

12. The network hardware device according to claim 11, wherein the predetermined period of time is 20 seconds or less.

13. The network hardware device according to claim 11, wherein the predetermined period of time is about 5 to 15 seconds.

14. The network hardware device according to claim 11, wherein the at least one processor is configured to cause the AP to repeat the QoS Null Data frame transmission to the wireless client device.

15. The network hardware device according to claim 14, wherein the at least one processor is configured to maintain the wireless client device on the active status client list of the AP if at least one ACK frame transmission is received by the access point from the wireless client device within the predetermined period of time.

16. The network hardware device according to claim 11, wherein wireless communication with the AP is available over multiple different frequency bands,
wherein the AP maintains a separate active status client list for each of the multiple different frequency bands, and
wherein the AP limits each wireless client device to having an active status on only one of the multiple different frequency bands at any given point in time.

17. The network hardware device according to claim 16, wherein the AP comprises a dual band Wi-Fi router in which the multiple different frequency bands include a 5 GHz band and a 2.4 GHz band, between which a wireless client device may switch in communicating with the AP.

18. The network hardware device according to claim 16, wherein the at least one processor is configured to obtain separate active status client lists for wireless client devices connected to the AP on each of the multiple different frequency bands.

19. The network hardware device according to claim 11, wherein the at least one processor is configured to match a source media access control (MAC) address within any ACK frame wireless transmission received by the AP with a MAC address of a wireless client device that is listed in the active status client list, to determine the wireless client device from which the ACK frame wireless transmission was received.

20. The network hardware device according to claim 11, wherein the at least one processor is configured to start a timer, after transmitting the QoS Null Data frame transmission, for determining if an ACK frame wireless transmission is received by the AP within the predetermined period of time.
